(19) United States
(12) Patent Application Publication
(10) Pub. No.: US 2006/0093763 A1
(43) Pub. Date: May 4, 2006

(54) Gas hermetic bag packaging material and advertisement medium

(76) Inventor: Yasusumi Tanaka, Kanagawa (JP)

Correspondence Address: MORRISON & FOERSTER LLP, 1650 TYSONS BOULEVARD, SUITE 300, MCLEAN, VA, 22102, US

(21) Appl. No.: 10/507,161

(22) PCT Filed: Jun. 30, 2004
(86) PCT No.: PCT/JP04/09191

§ 371 Date: Sep. 9, 2004

(51) Int. Cl. B32B 27/32

(52) U.S. Cl. 428/35.2

(57) ABSTRACT

The present invention provides a gas hermetic bag which can easily be shipped and produced, and in which a shape of the gas hermetic bag capable of protecting corner portions of an article is formed by supplying gas into the gas hermetic bag to expand the air hermetic bag, and which has protecting function suitable for protecting corner portions of articles having various sizes and shapes. In the gas hermetic bag, plastic films are superposed on each other and peripheries thereof are tightly closed by thermal welding and gas is charged into the gas hermetic bag. The gas hermetic bag 10′ has a triangle pole shape in which a bottom surface thereof has an isosceles triangle Q shape and a side surface thereof has a rectangle shape, and a surface facing a vertex angle of the pole is opened.

### TECHNICAL FIELD

The present invention relates to a plastic gas hermetic bag utilizing gas as a cushioning for protecting corner portions of an article to be packaged, and the invention also relates to a packaging material and an advertisement medium.

### BACKGROUND ART

Generally, an electric appliance such as a notebook computer is packaged using styrofoam as a cushioning. The styrofoam becomes a great burden before the packaging operation in terms of a storage space and distribution costs. When the styrofoam is to be disposed of, there are concerns of influence of endocrine disruptor such as dioxin generated when the styrofoam is burned. In order to solve such problems, the demand for usages of plastic films as a packaging air cushioning is increasing.

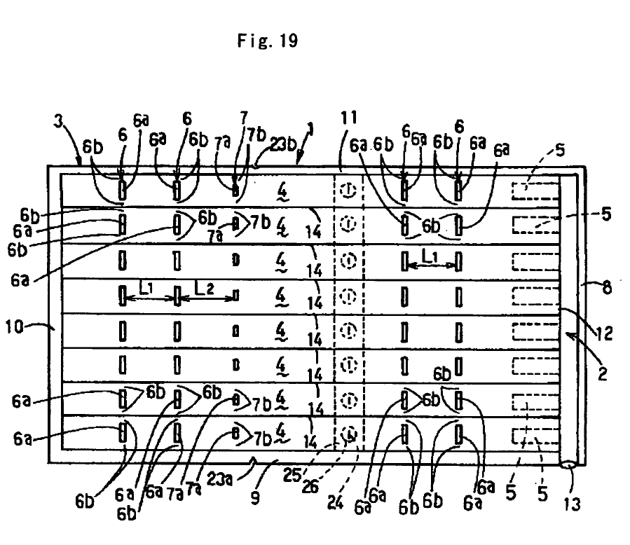

A gas hermetic bag made of plastic film is conventionally used as a packaging air cushioning in various manner (see Patent Literatures 1 to 6 for example). Especially a gas hermetic bag described in Patent Literature 1 includes an air supply passage 2 formed by superposing plastic films on each other and adhering necessary portions of the plastic films to each other, and an air hermetic bag 3 continuously connected to one side edge of the air supply passage 2 as shown in FIG. 19. The hermetic bag 3 is provided with a plurality of air-divided hermetic bags 4 formed by adhering the hermetic bag 3 at a plurality of locations thereof, and check valves 5 capable of independently bringing the divided hermetic bags 4 and the supply passages into communication and out of communication with each other. According to this gas hermetic bag, opposite sides of the hermetic bag 3 are individually adhered at two line each in a direction crossing the hermetic bags 4 to form creases 6, and an accommodation space of an article to be packaged having a necessary depth is naturally formed in the gas hermetic bag by the creases 6.

[Patent Literature 1] Japanese Patent Application Laid-open No. 2002-225945

[Patent Literature 2] Japanese Patent Application Laid-open No. 2003-175944

[Patent Literature 3] Japanese Utility Model Application Laid-open No. H1-164142

[Patent Literature 4] Japanese Patent Application Laid-open No. 2002-104520

[Patent Literature 5] Japanese Utility Model Application Laid-open No. H1-164142

[Patent Literature 6] Japanese Patent Application Laid-open No. H7-10159

### DISCLOSURE OF THE INVENTION

[Problems to be Solved by the Invention]

In the above gas hermetic bag, however, since it is necessary that the hermetic bag body has enough size for covering the entire article to be packaged, there is a problem that a large volume of plastic films is required when the volume of the article is large.

Further, since the thickness of the gas hermetic bag is insufficient as compared with the styrofoam, protection of corner portions is insufficient, and the corner portions of the article may be damaged when the article is transferred.

In view of the above problems, it is an object of the present invention to provide a gas hermetic bag which can easily be shipped and produced, and in which a shape of the gas hermetic bag capable of protecting corner portions of an article is formed by supplying gas into the gas hermetic bag to expand the air hermetic bag, and which has protecting function suitable for protecting corner portions of articles having various sizes and shapes. It is another object of the invention to provide a packaging material using the gas hermetic bag, and to an advertisement medium.

[Means for Solving the Problems]

Features of the present invention which are means for solving the problems are as follows:

1. A gas hermetic bag in which plastic films are superposed on each other and peripheries thereof are tightly closed by thermal welding and gas is charged into the gas hermetic bag, wherein the gas hermetic bag is folded and thermally welded to form a space therein, and the bag has a triangle pole shape in which a bottom surface thereof has an isosceles triangle shape and a side surface thereof has a rectangle shape, and a surface facing a vertex angle of the pole is opened.

2. The gas hermetic bag according to the invention of the paragraph 1, wherein the gas hermetic bag is provided with a partitioning structure.

3. The gas hermetic bag according to the invention of the paragraph 1, wherein the gas hermetic bag is provided with a film added between the plastic films, thereby forming the partitioning structure.

4. The gas hermetic bag according to the invention of the paragraph 3, wherein the partitioning structure adds the film between the two plastic films.

5. The gas hermetic bag according to any one of the inventions of the paragraphs 3 and 4, wherein a plurality of surfaces having the partitioning structures are overlapped on each other by adding the film.

6. The gas hermetic bag according to the invention of the paragraph 5, wherein when a plurality of surfaces to be repeatedly overlapped on each other are provided, a distance between added films in each row is the same, and films to be added in upper and lower rows are arranged on one line.

7. The gas hermetic bag according to the invention of the paragraph 5, wherein when a plurality of surfaces to be repeatedly overlapped on each other are provided, a distance between added films in each row is the same, and films to be added in upper and lower rows are offset from each other by ½ distance.

8. The gas hermetic bag according to any one of the inventions of the paragraphs 5 to 7, wherein when a plurality of surfaces to be repeatedly overlapped on each other are provided, an area of a lower row is larger than an area of an upper row, and a step structure is formed by each row.

9. The gas hermetic bag according to any one of the inventions of the paragraphs 2 to 8, wherein two rows or more partitions on the surface of the isosceles triangle are provided, and a width of the lower row is smaller than a width of the upper row.

10. The gas hermetic bag according to any one of the inventions of the paragraphs 2 to 9, wherein the partitions in the side surface have the same widths.

11. The gas hermetic bag according to any one of the inventions of the paragraphs 1 to 10, wherein a vertex angle of the gas hermetic bag is not thermally welded.

12. A gas hermetic bag in which plastic films are superposed on each other and peripheries thereof are tightly closed by thermal welding and gas is charged into the gas hermetic bag, wherein the gas hermetic bag is folded and thermally welded to form a space therein, the bag has a vertical standing surface commonly having a triangular or tetragonal bottom surface and any of sides of the bottom surface.

13. The gas hermetic bag according to the invention of the paragraph 12, wherein the gas hermetic bag is provided with a partitioning structure.

14. The gas hermetic bag according to the invention of the paragraph 12, wherein the gas hermetic bag is provided with a film added between the plastic films, thereby forming the partitioning structure.

15. The gas hermetic bag according to the invention of the paragraph 12, wherein the partitioning structure adds the film between the two plastic films.

16. The gas hermetic bag according to any one of the inventions of the paragraphs 14 and 15, wherein a plurality of surfaces having the partitioning structures are overlapped on each other by adding the film.

17. The gas hermetic bag according to the invention of the paragraph 16, wherein when a plurality of surfaces to be repeatedly overlapped on each other are provided, a distance between added films in each row is the same, and films to be added in upper and lower rows are arranged on one line.

18. The gas hermetic bag according to the invention of the paragraph 16, wherein when a plurality of surfaces to be repeatedly overlapped on each other are provided, a distance between added films in each row is the same, and films to be added in upper and lower rows are offset from each other by ½ distance.

19. The gas hermetic bag according to any one of the inventions of the paragraphs 16 to 18, wherein when a plurality of surfaces to be repeatedly overlapped on each other are provided, an area of a lower row is larger than an area of an upper row, and a step structure is formed by each row.

20. The gas hermetic bag according to any one of the inventions of the paragraphs 13 to 19, wherein two rows or more partitions on the surface of the isosceles triangle are provided, and a width of the lower row is smaller than a width of the upper row.

21. The gas hermetic bag according to any one of the inventions of the paragraphs 13 to 20, wherein the partitions in the side surface have the same widths.

22. The gas hermetic bag according to any one of the inventions of the paragraphs 1 to 21, wherein at the time of the thermal welding, the gas communicating portion is provided by a peeling-off operation.

23. The gas hermetic bag according to any one of the inventions of the paragraphs 1 to 22, further comprising at least one gas charging port, wherein the gas charging port prevents gas charged by a check valve from flowing reversely.

24. The gas hermetic bag according to any one of the inventions of the paragraphs 1 to 22, further comprising at least one gas charging port, wherein the gas charging port prevents gas charged by a labyrinth structure of a check valve from flowing reversely.

25. The gas hermetic bag according to any one of the inventions of the paragraphs 1 to 24, further comprising an attached gas hermetic bag provided separately from the body, wherein the attached gas hermetic bag is connected to a tip end of a connection which has at least two gas communicating narrow passages and which can be bent such that gas can flow between the body and the connection.

26. A gas hermetic bag in which plastic films are superposed on each other and peripheries thereof are tightly closed by thermal welding and gas is charged into the gas hermetic bag, wherein a film is added between the plastic films and a partitioning structure is applied, thereby flattening a surface of the bag.

27. The gas hermetic bag according to the invention of the paragraph 26, wherein a plurality of surfaces to which the partitioning structure is applied by adding the film are overlapped on each other.

28. A packaging material for protecting a periphery of an article to be packaged, wherein the gas hermetic bag according to any one of the inventions of the paragraphs 1 to 27 is used as the packaging material.

29. An advertisement medium for displaying an advertisement on a periphery of a gas hermetic bag, wherein the gas hermetic bag according to any one of the inventions of the paragraphs 1 to 27 is used as the advertisement medium.

[Effect of the Invention]

By the above solving means, the gas hermetic bag of the present invention can stably protect the corner portions of the articles having various sizes and shapes. Since air can be injected into the bag when the bag is used, the hermetic bag itself can easily be stored and shipped.

The packaging material of the present invention can protect an article using the above gas hermetic bag, and the packaging material can protect the article by enveloping the corner portions of the article.

According to the advertisement medium of the invention, an advertisement can be printed or described on a surface of the gas hermetic bag which can form a flat surface even if air is injected into the bag.

### BEST MODE FOR CARRYING OUT THE INVENTION

### FIRST EMBODIMENT

Embodiments of the gas hermetic bag according to the present invention will be explained with reference to the accompanying drawings below.

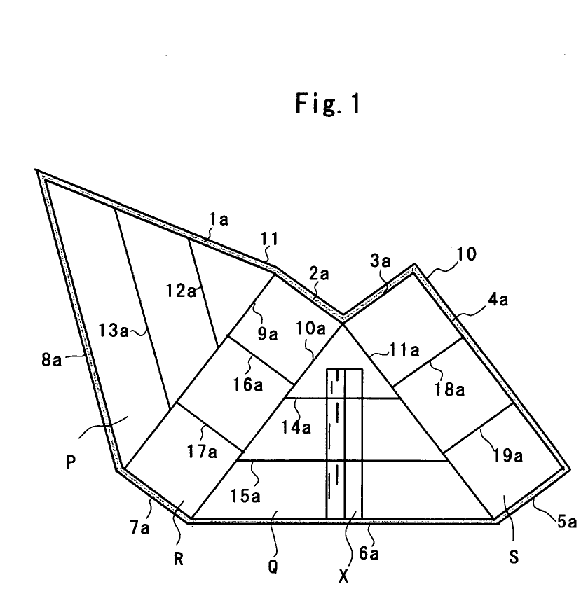

FIG. 1 is a plan view of a base body of a gas hermetic bag according to a first embodiment of the invention. A reference numeral 10 represents a base body of the gas hermetic bag of the invention. In this embodiment, two thermally welded plastic films (sheets) each having a triangular shape, a rectangular shape, a triangular shape and a rectangular shape are superposed on each other. The two plastic films have the same shapes and the same sizes. Necessary locations of the plastic films are heated and adhered to each other to form a gas hermetic bag body 11. A sheet member X which is a check valves is sandwiched between two sheets which constitute the gas hermetic bag body 11 at a position Q or P of the gas hermetic bag body 11. This sheet member X also functions as a gas charging port.

The base body 10 of the gas hermetic bag is provided with creases 9a to 11a for forming the hermetic bag into a triangle pole structure when air is supplied into the gas hermetic bag to expand the same, and with partitioning portions 12a to 19a which form step structures on a surface of the hermetic bag.

The partitioning portions 16a to 19a of the rectangular surface are designed such that widths of rows are equal to each other. The partitioning portions 12a to 15a of the triangular surface are straight lines which are in parallel to bottom sides, and widths of the rows are gradually reduced toward lower rows. Three rows or more formed by the partitioning portions may be provided.

The sheet member X functions as a check valve. The sheet member X comprises two rectangular thermally adhesive plastic films superposed on each other. The plastic film is made of soft and thin material such as polyethylene film.

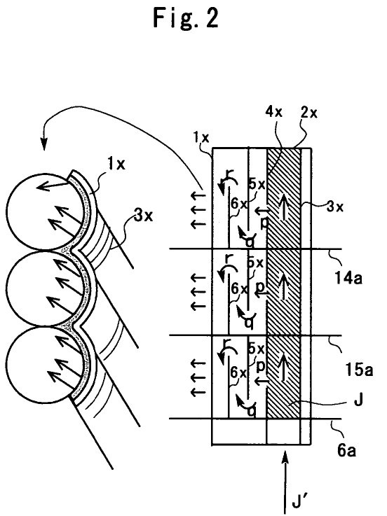

FIG. 2 is an enlarged view of a structure around the sheet member X. There is provided a thermally welded portion 2× which supports the sheet member X integrally with two plastic films which constitute the gas hermetic bag body 11. There are also provided partially welded portions 5× and 6× which form a gas passage. At a position of a gas injecting section J shown with oblique lines in the drawing, an inner surface of the sheet member X is peeled off so that the sheet member X is not heated.

The gas hermetic bag body 10 is formed by heating and welding peripheries 1a to 8a, the creases 9a to 11a and the partitioning portions 12a to 19a of the two superposed plastic films having the same shapes and the same sizes.

At the time of the heating and welding operation, the sheet member X is previously sandwiched between the two plastic films, thermally welded portions 2× to 4× and the partially welded portions 5× and 6× are simultaneously heated and welded. With this procedure, the gas hermetic bag body 10 integrally provided with the sheet member X can efficiently be formed.

The partially welded portions 5× and 6× are provided for forming labyrinth structures in the sheet member X using narrow gas passages q and r, and for allowing the sheet member X to function as a check valve.

The creases 9a to 11a are heated and welded so that partially adhered portions and partially communicated portions are alternately provided. Gas can flow through the creases 9a to 11a through the partially communicated portions.

Similarly, in the welded portion 4× of the sheet member X, it is necessary to provide a partially communicated portion p in each row of the gas hermetic bag body so that gas can flow.

In this embodiment, the entire surfaces of the partitioning portions 12a to 19a are not provided with the partially communicated portions but are heated and welded.

In this embodiment, the plastic film constituting the gas hermetic bag is formed by laminating, on one another, a film having heat sealing function such as polyethylene and polypropylene; a film such as polyamide, fluorocarbon resin and silicone; and a film having heat sealing function such as polyethylene and polypropylene.

A metal film such as an aluminum film may be sandwiched.

The reason why the material having the heat sealing function appears on both surfaces of the plastic film is that in order to form the gas hermetic bag body into a bag, it is necessary to thermally welding the inner surfaces to each other, and in order to form the gas hermetic bag body into a three dimensional bag, it is necessary to thermally welding the outer surfaces to each other. The intermediate film is provided taking gas permeability into account.

In a forming procedure of the base body 10 of the gas hermetic bag, the sheet member X is sandwiched between the two plastic films constituting the gas hermetic bag body 11, a weld-hindering material such as a heat resistance ink is applied or gravure printed on inner portions of a front film and a back film at locations corresponding to the partially communicated portions of the gas hermetic bag body 11, thereby peeling the material off. The peripheries 1a to 8a, the creases 9a to 11a, the partitioning portions 12a to 19a, the welded portions 2× to 4×, and the partially welded portions 5× and 6× are uniformly heated and welded. Also with these operations, the base body 10 of the gas hermetic bag having the partially communicated portion can be formed and thus, the bag-forming operation can be simplified.

Concerning this peeling-off operation, a material which does not have thermally adhesive properties such as a cellophane can be sandwiched between locations corresponding to the partially communicated portions instead of applying ink or the like.

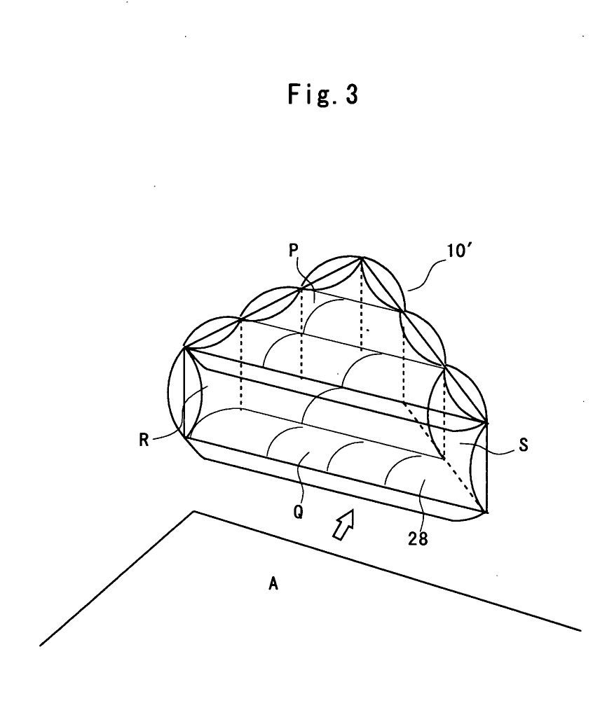

According to the gas hermetic bag of the present invention, the base body 10 of the gas hermetic bag shown in FIG. 1 is folded by the creases 9a, 10a, and 11a, thereby connecting the peripheries 1a and 4a to the peripheries 2a and 3a, and the entire region is heated and adhered, thereby obtaining a structure as shown in FIG. 3.

In this embodiment, a vertex angle of an isosceles triangle of the base body 10 of the gas hermetic bag having a P plane and a Q plane is set to 78°. With this design, in a gas hermetic bag 10′ after the bag is formed into the three dimensional shape, a corner of a location of the bag into which a corner of an article to be packaged (hereinafter, “article”) A is to be inserted achieves a right angle. If cylindrical partition widths are varied, it is necessary to set this angle value in each case.

FIG. 1 shows the gas hermetic bag body 10 forming the gas hermetic bag 10′ shown in FIG. 3 by connecting one side 1a of the triangle and one side 4a of the rectangle. Alternately, it is also possible to form the bag using a base body 20 of a base body hermetic bag comprising a semi-triangle, a rectangle, an isosceles triangle, a rectangle and a semi-triangle. Here, concerning the term “semi-triangle”, the isosceles triangle located at the center is equally divided into two at a center line, and one of the divided isosceles triangles is the semi-triangle. In this embodiment, the peripheries 1b and 4b which are sides of the semi-triangle are connected to each other such that the connected portions appear on an upper surface of the hermetic bag, and the peripheries 2b and 3b are connected to each other and heated and adhered. With this operation, a gas hermetic bag having the same shape as shown in FIG. 2 can be obtained.

In the gas hermetic bag body 21, in addition to the creases 16b to 19b, the partitioning portions 10b to 15b and 20b to 23b are also provided with gas communicating portions so that the entire gas hermetic bag can be expanded using one check valve.

A using state, working operation, and effect of the above gas hermetic bag will be explained.

The sheet member X is the check valve having a function as a gas charging port. A remover is applied to the sheet member X, an air injecting pipe is inserted into a position of the gas injecting section J in the direction shown with J′ in FIG. 2 so that this portion is not welded. If air is supplied from the injecting pipe under pressure, the air passes through the partially communicated portions p of the rows, and passes through the gas passages q and r having the labyrinth structure of the rows, and finally flows out from the sheet member end 1× toward the gas hermetic bag body 11.

That is, the sir supplied from the sheet member end 1× expands the entire gas hermetic bag body 11, and the gas passage in the sheet member X is closed by the internal pressure so that the air supplied into the base body under pressure can not flow reversely.

A check valve having a function as a gas charging port may be provided instead of the sheet member X so that the gas injected inside does not flow reversely. The check valve is formed in such a manner that two plastic films such as polyethylene films are formed into rectangular shape and are superposed on each other, and a weld-hindering layer is formed between the two plastic films. The check valve is integrally provided with the gas charging port. Gas is allowed to flow from the gas charging port in the direction of the hermetic bag body, the gas is introduced into the gas hermetic bag body 11, and a back flow of the gas is hindered.

At that time, in the base body of the gas hermetic bag shown in FIG. 1, since the entire region of the partitioning portion is thermally welded, it is necessary to sandwich the check valve between the two plastic films constituting the gas hermetic bag body 11 in each row at location of the periphery 1a or 4a.

A plastic check valve of this kind is known (see for example, Japanese Utility Model Application Laid-open No. H1-164142 and Japanese Patent Application Laid-open No. H7-10159) and thus, details thereof are omitted. The creases 9a to 11a are provided with the partially adhered portions and the partially communicated portions alternately and heated and welded. Therefore, air supplied into the gas hermetic bag body 11 can pass through the partially communicated portions of the creases 9a to 11a and reliably expand the entire gas hermetic bag body 11.

By providing the creases 9a to 11a with the partially communicated portions, flexibility is generated around the creases as compared with a case where the creases 9a to 11a are uniformly heated and welded. With this flexibility, there is an effect that this portion can be folded.

In this embodiment, the partitioning portions 12a to 19a are uniformly thermally welded so that gas can not flow between the rows. With this structure, even if one of the rows is damaged by collision or the like, this does not affect the entire gas hermetic bag, and the bag can be used continuously.

Side surfaces R and S of the gas hermetic bag body 10′ are formed with steps having the same swelling volumes by the partitioning portions 16a to 19a. Therefore, the gas hermetic bag body 10′ can equally receive an impact from the side surface.

An upper surface P and a bottom surface Q of the gas hermetic bag body 10′ are formed with rows by the partitioning portions 12a to 15a. A vertical width of this row is gradually reduced toward its lower end. This will be explained in detail. In the case of a surface of a triangle, a length of a lower row in the partitioning portion direction becomes longer. Thus, when the widths of the rows are set equal to each other, if air is inserted to form this portion into a cylindrical shape, a volume of a lower row is greater and as a result, a cylinder of a lower row has a larger diameter. With such a structure, a surface of the triangle does not stably abut against a flat surface, and the article can not be packaged stable. To avoid such a structure, the above idea is employed so that the surface of the triangle abuts against the flat surface in a flat manner and the article can be packaged stably. The gas hermetic bag body 10′ protects a corner of the article A inserted from its opening 28. Concerning the remaining three corners of the article A, if the article A is inserted into the gas hermetic bag body 10′, the entire article A can stably be protected by the four corners of the article A.

The thickness of the side surface can appropriately be changed so that various heights of the articles A can be accepted.

According to the gas hermetic bag body 10′ of the present invention, when the bags protecting the articles are stacked on one another, a corrugated cardboard need not be sandwiched between the bags, and the gas hermetic bags can directly be stacked on one another. Therefore, the amount of waste generated when protecting the articles is reduced, and the article can be protected stably.

FIGS. 1, 3, and 4 show that the vertex angle of the gas hermetic bag body 10′ after it is formed into the three dimensional shape is closed. The vertex angle of the gas hermetic bag of the invention may be opened. In this case, the article A is protected in a state where the corners of the article A slightly protrude from the opened vertex portion of the gas hermetic bag body.

In FIGS. 1, 3, and 4, the partitions in the surface of the triangle are provided by the straight lines which are parallel to the bottom side. Alternatively, the partition may be provided by a plurality of straight lines extending from the vertex portion toward the bottom side.

### SECOND EMBODIMENT

FIG. 5 is a plan view of a base body 30 of a gas hermetic bag according to a second embodiment of the present invention. In this embodiment, a gas hermetic bag body 31 comprises two plastic films having the same shapes and the same sizes. The plastic film has a rectangle, a triangle, and a rectangle in shape. In this embodiment, a check valve 33 having a function as a gas charging port is sandwiched between the two plastic films in each row at a position 1c or 4c. Peripheries 1c to 7c, creases 16c and 17c and partitioning portions 8c to 15c are heated and welded, thereby forming the base body 30 of the gas hermetic bag.

In this embodiment, the creases 16c and 17c are provided with gas communicating portions, but in order to provide the gas communicating portions, it is necessary to apply a weld-hindering material between a front film and a back film at corresponding locations to heat and adhere the films.

Also in this second embodiment, like the first embodiment, the partitioning portions 8c to 13c in the surface of the rectangle have the same heights, and the partitioning portions 14c and 15c in the surface of the triangle have lower height toward the bottom.

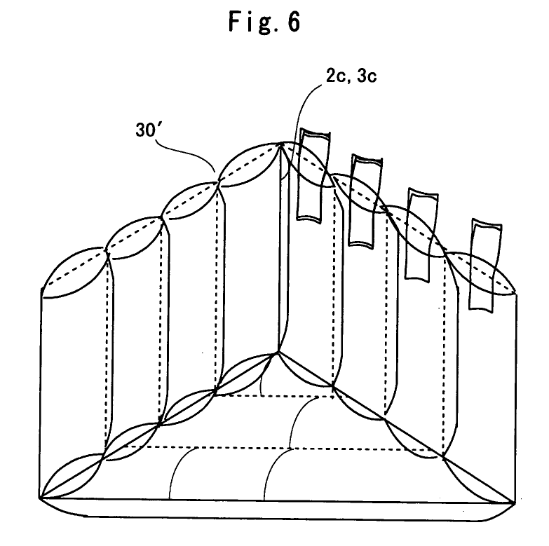

According to the gas hermetic bag of this embodiment, the base body 30 of the gas hermetic bag is folded at the creases 16c and 17c, the peripheries 2c and 3c are connected to each other and heated and adhered. After gas is injected into the bag, corners of the article shown in FIG. 6 are protected.

Unlike the first embodiment, the gas hermetic bag of the second embodiment does not have an upper surface and thus, the corners can be protected irrespective of the height of the article.

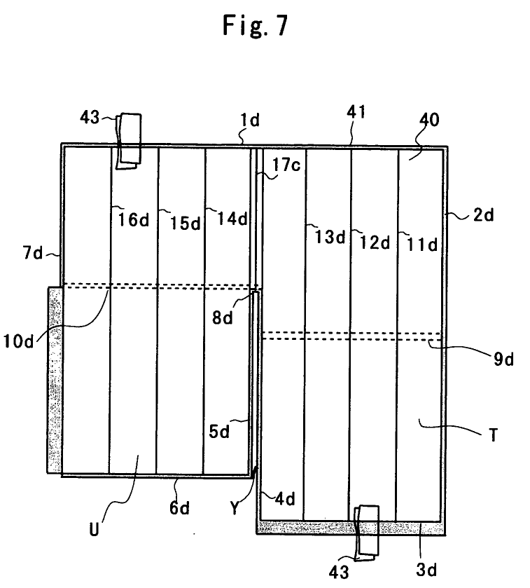

FIG. 7 shows a base body 40 of a gas hermetic bag having no upper surface like the gas hermetic bag 30. The base body 40 has a tetragonal bottom surface.

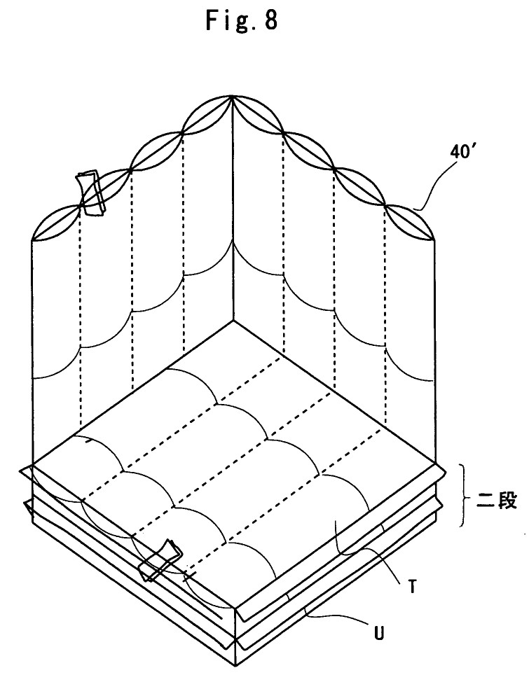

Also in this case, like the gas hermetic bags 10, 20, and 30, the base body 40 of the gas hermetic bag includes a check valve 43 having a function as a gas charging port between the two plastic films having the same shapes. The check valve 43 is sandwiched between positions 3d and 1d and the plastic films are heated and welded. The check valve sandwiched at the position 1d is sandwiched at a region between the positions 7d and 17d. At that time, it is necessary to carry out the peel-off operation at necessary positions of the partitioning portions 11d to 16d in addition to the creases 9d and 10d to heat and weld so as to provide a gas communicating portion. A bottom surface T is turned and folded at right angles such that the bottom surface T comes on a bottom surface U at a gap Y by the creases 9d, 10d, and 17d, and corners are formed by the creases 9d, 10d, and 17d as shown in FIG. 8. In this case, there are two bottom surfaces T and U.

In FIG. 7, the partitioning portion is provided with the gas communicating portion so that gas can flow between cylinders. With this structure, if each side of the gas hermetic bag body includes one check valve, the entire gas hermetic bag can be expanded. Alternatively, the entire region of the partitioning portion may be thermally welded and each row may have the check valve 43.

Further, a check valve which stops the flow of gas using the internal pressure may be provided to prevent the back flow of gas like the first embodiment.

### Third Embodiment

In the previous embodiments, the partitioning portion is provided by thermal welding. Alternatively, this partitioning portion may be provided by a short width plastic film which is added between the plastic films constituting the base body and by heating and adhering the same.

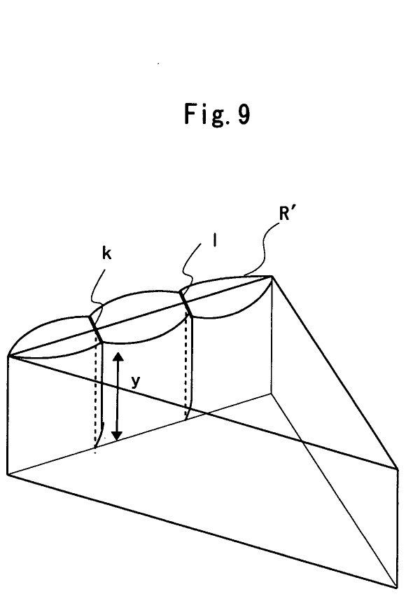

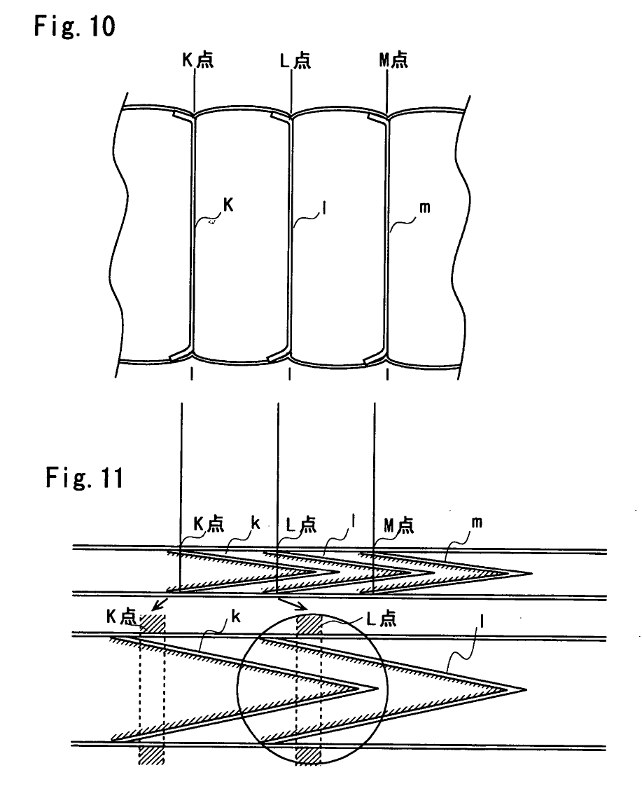

FIG. 9 is a stereograph of a gas hermetic bag according to the third embodiment, and FIG. 10 is an enlarged sectional view of a side surface of the gas hermetic bag.

FIG. 11 shows the cross section shown in FIG. 10 before gas is injected. Partitioning plastic films k, l, and m are added between the two plastic films constituting the gas hermetic bag body at each of points K, L, and M. The partitioning plastic films are folded in a form of an angle shape. In this state, if the heating operation is carried out at the points K, L, and M, the partitioning plastic films k, l, and m can be supported integrally with the upper and lower plastic films constituting the gas hermetic bag body. Inner surfaces of the partitioning plastic films k, l, and m are subjected to the peeling-off operation so that the inner surfaces are not thermally welded. Portions of the partitioning plastic films k, l, and m are overlapped on one another, but inner sides of partitioning plastic film l and m are also subjected to the peeling-off operation so that the overlapped films are not welded to each other. Thus, even if the points K, L, and M are close to each other, the working can be carried out.

If air is inserted into the gas hermetic bag in this state, a portion of the gas hermetic bag shown in FIG. 11 assumes a shape shown in FIG. 10, and a center core generated by the added film exists between the upper and lower plastic films constituting the gas hermetic bag. In this embodiment, the partitioning structure is provided in the gas hermetic bag as shown in FIG. 9 by the added film.

In this embodiment, when it is necessary to provide the partitioning portion in a state where the gas communicating portion is provided, an end of the film to be added in a direction y in FIG. 9 is provided at a halfway position of the gas hermetic bag body. With this structure, a gas flowing portion can be secured.

A thickness of the surface partitioned by this embodiment is increased as compared with a surface which is partitioned by thermal welding.

In the case of partitioning made by the thermal welding, the number of contacts between the cylinders constituting a surface is one, and the internal pressure is concentrated on this contact. Whereas, in the case of partitioning made by this added film, the number of contacts between the cylinders is two and thus, the internal pressure is dispersed and cushioning properties are remarkably enhanced.

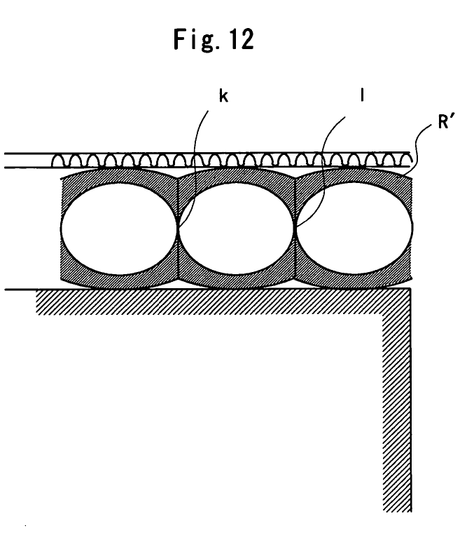

FIG. 12 shows the gas hermetic bag shown in FIG. 10 is fixed to an article. Due to the above effect, the gas hermetic bag partitioned by the added film can protect a heavier article as compared with a gas hermetic bag partitioned by thermal welding.

If a distance between the partitions is reduced, the number of columns formed in the surface is increased, and a force capable of resisting a weight of the article is increased.

If a height (shown with y in FIG. 9) of the film is increased with respect to the distance between the partitions, the number of bumps and dips on the partitioned surface is reduced. Thus, when the article is packaged, the article can be protected more stably.

In this embodiment, the film to be formed with the partitions is of a plate-like shape, but the film may be formed into a ring-like shape. Also in this case, it is necessary to carry out the peeling-off operation at a location where the films are overlapped on each other.

In FIG. 9, the partitioning structure of this embodiment is applied to the side surface of the gas hermetic bag of the first embodiment. This partitioning structure can also be applied to each surface of the gas hermetic bag of other embodiments.

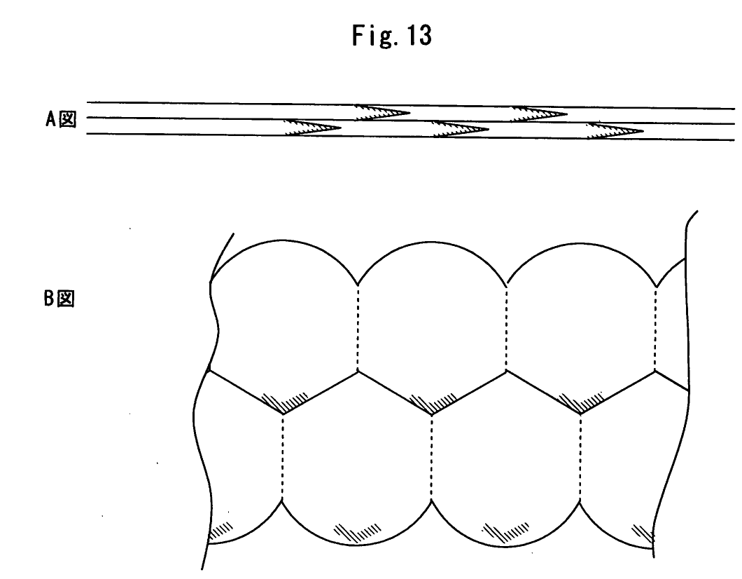

FIG. 13 show a structure wherein a plurality of partitioning structures partitioned by the added film as shown in FIGS. 9 to 12 are provided.

FIG. 13A is a sectional view of one surface of the gas hermetic bag before gas is charged, and FIG. 13B shows the gas hermetic bag into which gas is charged. Like the gas hermetic bag shown in FIG. 11, the peeling-off operation is carried out on an inner side surface of the film added as a partition. In FIG. 13, centers of first and second partitioning portions are offset by half. With this structure, the plurality of partitions are stably realized.

If three or more partitioning structures by means of the added films are provided, the inside of the cross section becomes honeycomb shape, and since a plurality of cylinders constituting the surface are overlapped on each other, synergism between the cylinders is generated, and a pressure of a heavy article can equally be dispersed.

Therefore, the plurality of partitioning structures shown in FIG. 13 are applied to each surface of the gas hermetic bag, a gas hermetic bag capable of resisting heavier weight can be realized.

Although the centers of the partitioning portions are offset by half in FIG. 13, the partitions of each row may be arranged on one line.

When the plurality of partition structures are to be applied to the surface of the gas hermetic bag, an area of the structure may be gradually increased from an upper row toward a lower row in a stepped manner.

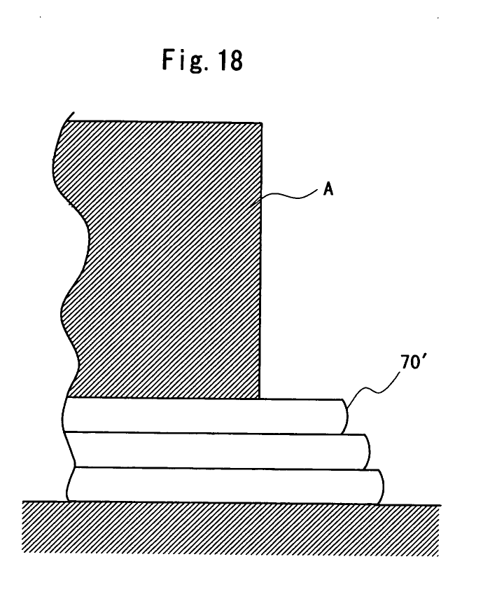

FIG. 18 shows a gas hermetic bag attached to the article A as viewed from a side where a plurality of steps are provided in the stepped manner. With this structure, when the article comes out from the gas hermetic bag, the article is prevented from being seriously damaged, and there is an effect that the article can stably be protected by the gas hermetic bag to which the plurality of stepped surfaces are applied.

### FOURTH EMBODIMENT

The partitioning structure of the third embodiment can be applied to a gas hermetic bag where rectangular plastic films are overlapped on each other, a flat plate-like gas hermetic bag is formed, and this can be used as an advertisement signboard. At that time, if gas which is lighter than air is injected into the gas hermetic bag, it can float in the air. Furthermore, the gas hermetic bag may be used with an illumination lamp to be inserted into the base body.

### FIFTH EMBODIMENT

If a structure for bending at an arbitrary place is provided at an end simultaneously with the gas hermetic bag, even if an article having such a shape that a partial gap is formed with respect to the gas hermetic bag body can suitably be protected.

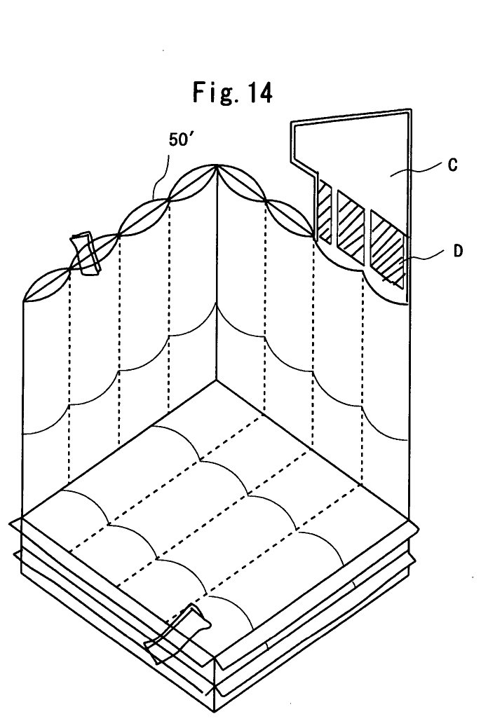

FIG. 14 shows a gas hermetic bag 50′ of a fifth embodiment. In the second embodiment, a base body 40 of a gas hermetic bag (see FIGS. 7 and 8) having a tetragonal bottom surface is bent. In this embodiment, the gas hermetic bag body and an attached gas hermetic bag C are connected to each other such that gas can flow therebetween through connections D. By providing a narrow passage having a small diameter in a gas communication passage, the connection D can be flexibly bent.

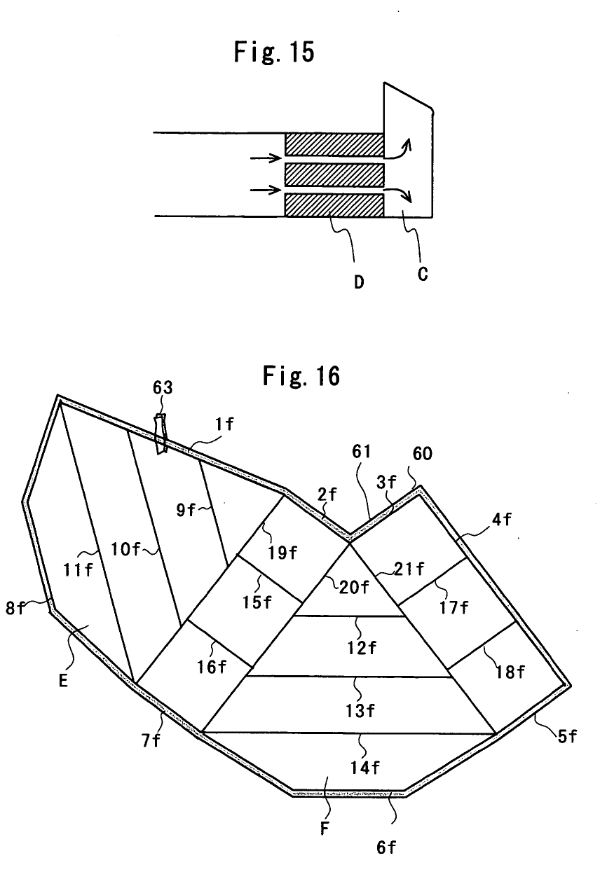

FIG. 15 shows positions of the attached gas hermetic bag C and the connections D in an enlarged scale in FIG. 14.

If such a structure is provided at a location where a gap is generated between the gas hermetic bag 50′ and an article, since the attached gas hermetic bag C can be bent and inserted into the gap at the connections D, it is possible to more stably protect an article having complicated shape.

In this embodiment, the base body 40 of the gas hermetic bag of the second embodiment is provided with the attached gas hermetic bag C and the connections D. This structure may also be applied to the gas hermetic bag of other embodiments.

### SIXTH EMBODIMENT

In a gas hermetic bag 60′ of the sixth embodiment, plays are provided at arbitrary locations of an end of the gas hermetic bag body so that when a volume of an article is small and four corners can not be protected, only two diagonals of the article are protected.

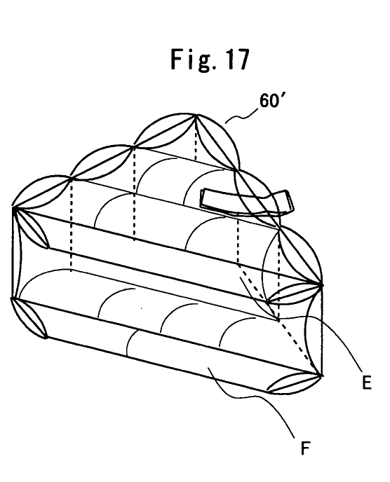

FIG. 16 is a plan view of a base body 60 of the gas hermetic bag of the sixth embodiment. Plays E and F are provided along peripheries 6a and 8a of the gas hermetic bag 10 (see FIGS. 1 and 3) in the first embodiment. FIG. 17a state where the base body 60 of the gas hermetic bag is formed three dimensionally and air is supplied and charged into the base body to expand the same.

Even after the base body 60 of the gas hermetic bag is formed three dimensionally, the plays E and F can longitudinally be bent freely. When the two diagonals of the article are protected, even if openings of the gas hermetic bags are opposed to and overlapped with each other, the plays can vertically be overlapped with each other, and an article having small volume can stably be protected.

In this embodiment, the base body 10 of the gas hermetic bag of the first embodiment has the plays E and F, but the plays may be provided in the gas hermetic bag of other embodiments also.

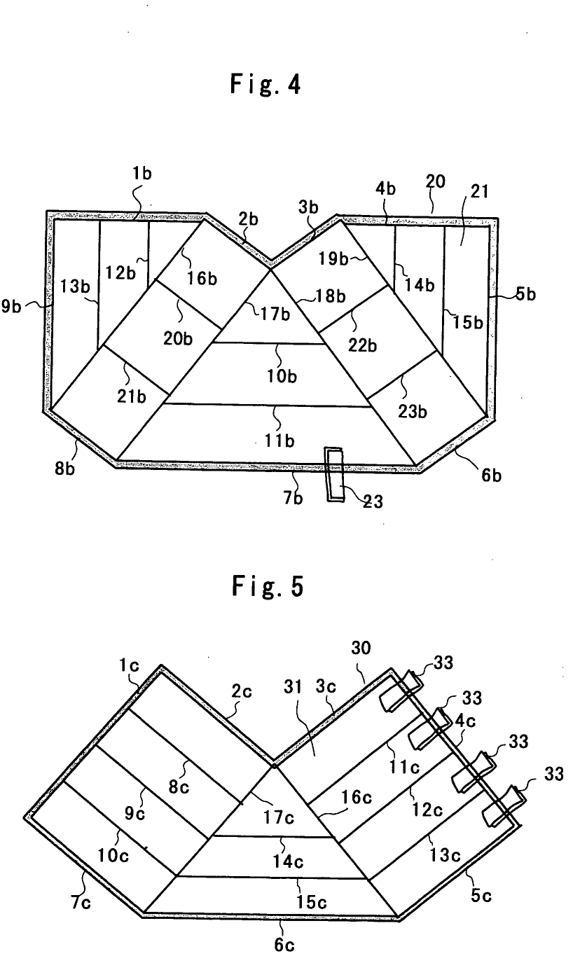

### BRIEF DESCRIPTION OF THE DRAWINGS

[FIG. 1] A plan view of a base body 10 of a gas hermetic bag according to a first embodiment of the present invention.

[FIG. 2] An enlarged view of a structure around a sheet member X.

[FIG. 3] A perspective view showing a state where the base body 10 of the gas hermetic bag is formed three dimensionally and air is supplied and charged into the base body to expand the same.

[FIG. 4] A plan view of a base body 20 of the gas hermetic bag of the first embodiment of the invention.

[FIG. 5] A plan view of a base body 30 of a gas hermetic bag of a second embodiment of the invention.

[FIG. 6] A perspective view showing a state where the base body 30 of the gas hermetic bag is formed three dimensionally and air is supplied and charged into the base body to expand the same.

[FIG. 7] A plan view of a base body 40 of the gas hermetic bag of the second embodiment of the invention.

[FIG. 8] A perspective view showing a state where the base body 40 of the gas hermetic bag is formed three dimensionally and air is supplied and charged into the base body to expand the same.

[FIG. 9] A stereograph of a gas hermetic bag according to a third embodiment.

[FIG. 10] An enlarged sectional view of a side surface of the gas hermetic bag shown in FIG. 9.

[FIG. 11] A cross section shown in FIG. 10 before gas is charged.

[FIG. 12] A state where the gas hermetic bag formed with partitions according to the third embodiment is fixed to an article.

[FIG. 13] Structures where a plurality of partitions formed by center cores shown in FIGS. 9 to 12 are provided.

[FIG. 14] A perspective view of a gas hermetic bag 50′ of a fifth embodiment of the invention.

[FIG. 15] An enlarged view of positions of an attached gas hermetic bag C and connections D shown in FIG. 14.

[FIG. 16] A plan view of a base body 60 of a gas hermetic bag of a sixth embodiment.

[FIG. 17] A perspective view showing a state where the base body 60 of the gas hermetic bag is formed three dimensionally and air is supplied and charged into the base body to expand the same.

[FIG. 18] A gas hermetic bag having a plurality of step structures and fixed to an article A as viewed from side.

[FIG. 19] A plan view of a conventional cushioning packaging bag in which a base body is folded and superposed on each other.

1-29. (canceled)

30. A packing material formed by holding a gas bag, comprising:
a first triangular wall;
a second triangular wall;
a first rectangular side wall; and
a second rectangular side wall, wherein
the first rectangular side wall connects a first side of the first triangular wall and a first side of the second triangular side wall,
the second rectangular side wall connects a second side of the first triangular wall and a second side of the second triangular wall, and
a third side of the first triangular wall and a third side of the second triangular wall are not connected to the first or second rectangular side wall so that an opening is created along the third sides of the first and second triangular walls.

31. The packing material of claim 30, further comprising a partition separating a portion of the gas bag from another portion of the gas bag.

32. The packing material of claim 31, wherein the partition comprises a film adhered to an inside wall of the gas bag.

33. The packing material of claim 30, further comprising a set of vertical partitions so that the gas bag is divided into a plurality of sub bags with respect to a plane parallel to a primary plane of the air bag, wherein each of the vertical partitions comprises a film.

34. The packing material of claim 33, further comprising a horizontal partition so that the gas bag is divided into a plurality of sub bags with respect to a plane normal to the primary plane, and another set of the vertical partitions, wherein the set of vertical partitions and the another set of the vertical partitions are disposed on opposite sides of the horizontal partition.

35. The packing material of claim 34, wherein an interval of the vertical partitions in the set and an interval of the vertical partitions in the another set is equal, and the vertical partitions are aligned in a line at respective positions in the air bag.

36. The packing material of claim 34, wherein an interval of the vertical partitions in the set and an interval of the vertical partitions in the another set is equal, and the vertical partitions of the set are positioned away from the vertical partitions of the another set by half the interval.

37. The packing material of claim 34, wherein a sub bag above the horizontal partition is narrower than a sub bag blow the horizontal partition so that a step structure is formed on a surface of the air bag.

38. The packing material of claim of claim 33, wherein a sub air bag in the first triangular wall located adjacent the third side of the first triangular wall is shorter than a sub air bag in the first triangular wall located away from the third side of the first triangular wall.

39. A packing material formed by holding a gas bag and adapted to cover a corner portion of an object, comprising:
a bottom wall that is triangular or rectangular;
a first side wall that stands on a first side of the bottom wall; and
a second side wall that stands on a second side of the bottom wall, wherein
an apex formed by the bottom wall and the first and second side walls is configured to cover the corner portion of an object.

40. The packing material of claim 39, further comprising a partition separating a portion of the gas bag from another portion of the gas bag.

41. The packing material of claim 40, wherein the partition comprises a film adhered to an inside wall of the gas bag.

42. The packing material of claim 39, further comprising a set of vertical partitions so that the gas bag is divided into a plurality of sub bags with respect to a plane parallel to a primary plane of the air bag, wherein each of the vertical partitions comprises a film.

43. The packing material of claim 42, further comprising a horizontal partition so that the gas bag is divided into a plurality of sub bags with respect to a plane normal to the primary plane, and another set of the vertical partitions, wherein the set of vertical partitions and the another set of the vertical partitions are disposed on opposite sides of the horizontal partition.

44. The packing material of claim 43, wherein an interval of the vertical partitions in the set and an interval of the vertical partitions in the another set is equal, and the vertical partitions are aligned in a line at respective positions in the air bag.

45. The packing material of claim 43, wherein an interval of the vertical partitions in the set and an interval of the vertical partitions in the another set is equal, and the vertical partitions of the set are positioned away from the vertical partitions of the another set by half the interval.

46. The packing material of claim 43, wherein a sub bag above the horizontal partition is narrower than a sub bag blow the horizontal partition so that a step structure is formed on a surface of the air bag.

47. The packing material of claim of claim 42, wherein a sub air bag in the triangular bottom wall located adjacent a side of the triangular bottom wall opposite from the apex is shorter than a sub air bag in the triangular bottom wall located away form the side of the triangular bottom wall.

48. A air bag comprising:
a first surface;
a second surface; and
a set of films each connecting the first and second surfaces, wherein
the films are disposed so that the first surface forms generally a flat surface.

49. The air bag of claim 48, further comprising a portioning surface formed between the first and second surfaces.
